(19) United States
(12) Patent Application Publication
(10) Pub. No.: US 2020/0401062 A1
(43) Pub. Date: Dec. 24, 2020

(54) ELECTROPHOTOGRAPHIC COMPOSITION

(71) Applicant: Hewlett-Packard Development Company, L.P., Spring, TX (US)

(72) Inventors: Hanit Marom Tchaicheeyan, Nes Ziona (IL); Albert Teishev, Nes Ziona (IL)

(21) Appl. No.: 16/957,279

(22) PCT Filed: Apr. 11, 2018
(86) PCT No.: PCT/US2018/027091

§ 371 Date: Jun. 23, 2020

(51) Int. Cl. G03G 9/135; G03G 9/13; C09D 11/107; C09D 11/033; G03G 15/16

(52) U.S. Cl. CPC G03G 9/1355; G03G 9/131; G03G 15/1605; C09D 11/033; C09D 11/107

(57) ABSTRACT

This disclosure relates to an electrophotographic composition including a thermoplastic polymer, a charge adjuvant, a liquid carrier, and at least one microcapsule including at least one additive encapsulated within a shell, wherein the shell of the microcapsule includes a material having a melting temperature of at least 50 degrees C.

### BACKGROUND

An electrophotographic printing process may involve creating an image on a photoconductive surface or photo imaging plate (PIP). The image that is formed on the photoconductive surface is a latent electrostatic image having image and background areas with different potentials. When an electrophotographic composition containing charged toner particles is brought into contact with the selectively charged photoconductive surface under an applied electric field, the charged ink particles adhere to the image areas of the latent image while the background areas remain clean. The image may then be transferred to an intermediate transfer blanket and then to the print substrate.

### BRIEF DESCRIPTION OF THE DRAWINGS

Various implementations are described, by way of example, with reference to the accompanying drawings, in which:

FIG. 1 is a schematic illustration of an example of a printer that may be used to perform an electrophotographic printing method according to one example of the disclosure;

FIG. 2 shows tested peel resistance of an electrophotographic ink composition when plastic films are treated with and without a polar solvent, and

FIG. 3 are photographs showing improved adhesion of an electrophotographic ink composition to a plastic film when treated with a primer.

### DETAILED DESCRIPTION

Before the present disclosure is described, it is to be understood that this disclosure is not limited to the particular process steps and materials disclosed in this description because such process steps and materials may vary. It is also to be understood that the terminology used in this disclosure is used for the purpose of describing particular examples. The terms are not intended to be limiting.

It is noted that, as used in this specification and the appended claims, the singular forms “a,” “an,” and “the” include plural referents unless the context clearly dictates otherwise.

As used in this disclosure, “co-polymer” refers to a polymer that is polymerized from at least two monomers. The term “terpolymer” refers to a polymer that is polymerized from 3 monomers.

As used in this disclosure, “melt index” and “melt flow rate” are used interchangeably. The “melt index” or “melt flow rate” refers to the extrusion rate of a resin through an orifice of defined dimensions at a specified temperature and load, reported as temperature/load, e.g. 190° C./2.16 kg. In the present disclosure, “melt flow rate” or “melt index” is measured per ASTM D1238-04c Standard Test Method for Melt Flow Rates of Thermoplastics by Extrusion Plastometer. If a melt flow rate of a particular polymer is specified, unless otherwise stated, it is the melt flow rate for that polymer alone, in the absence of any of the other components of the electrophotographic or electrostatic composition.

As used in this disclosure, “acidity,” “acid number,” or “acid value” refers to the mass of potassium hydroxide (KOH) in milligrams that neutralizes one gram of a substance. The acidity of a polymer can be measured according to standard techniques, for example as described in ASTM D1386. If the acidity of a particular polymer is specified, unless otherwise stated, it is the acidity for that polymer alone, in the absence of any of the other components of the liquid toner composition.

As used in this disclosure, “melt viscosity” generally refers to the ratio of shear stress to shear rate at a given shear stress or shear rate. Testing may be performed using a capillary rheometer. A plastic charge is heated in the rheometer barrel and is forced through a die with a plunger. The plunger is pushed either by a constant force or at constant rate depending on the equipment. Measurements are taken once the system has reached steady-state operation. One method used is measuring Brookfield viscosity @ 140° C., units are mPa-s or cPoise, as known in the art. Alternatively, the melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 Hz shear rate. If the melt viscosity of a particular polymer is specified, unless otherwise stated, it is the melt viscosity for that polymer alone, in the absence of any of the other components of the electrostatic or electrophotographic composition.

A polymer may be described as comprising a certain weight percentage of monomer. This weight percentage is indicative of the repeating units formed from that monomer in the polymer.

If a standard test is mentioned in this disclosure, unless otherwise stated, the version of the test to be referred to is the most recent at the time of filing this patent application.

As used in this disclosure, “electrostatic” or “electrophotographic” are used interchangeably. An “electrostatic” or “electrophotographic” printing process refers to a process that provides an image that is transferred from a photoconductive surface or photo imaging plate either directly or indirectly via an intermediate transfer member to a print substrate. As such, the image may not be substantially absorbed into the photo imaging substrate on which it is applied. Additionally, “electrophotographic printers” or “electrostatic printers” refer to those printers capable of performing electrophotographic printing or electrostatic printing, as described above. An electrophotographic printing process may involve subjecting the electrophotographic composition to an electric field, e.g. an electric field having a field gradient of 1-400V/μm, or more, in some examples 600-900V/μm, or more.

As used in this disclosure, the term “about” is used to provide flexibility to a numerical value or range endpoint by providing that a given value may be a little above or a little below the endpoint to allow for variation in test methods or apparatus. The degree of flexibility of this term can be dictated by the particular variable and would be within the knowledge of those skilled in the art to determine based on experience and the associated description in this disclosure.

As used in this disclosure, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

As used in this disclosure, the “average particle diameter” of the microcapsules can be determined by light scattering. In some instances, the particle size may be measured using laser diffraction or Low Angle Laser Light Scattering (LALLS). In some examples, the median value of the volume distribution, Dv(0.5) may be used to characterize microcapsule size.

Concentrations, amounts, and other numerical data may be expressed or presented in this disclosure in a range format. It is to be understood that such a range format is used merely for convenience and brevity and thus should be interpreted flexibly to include not just the numerical values explicitly recited as the limits of the range, but also to include all the individual numerical values or sub-ranges encompassed within that range as if each numerical value and sub-range is explicitly recited. As an illustration, a numerical range of “about 1 wt % to about 5 wt %” should be interpreted to include not just the explicitly recited values of about 1 wt % to about 5 wt %, but also include individual values and subranges within the indicated range. Thus, included in this numerical range are individual values such as 2, 3.5, and 4 and sub-ranges such as from 1-3, from 2-4, and from 3-5. This same principle applies to ranges reciting a single numerical value. Furthermore, such an interpretation should apply regardless of the breadth of the range or the characteristics being described.

The present disclosure relates to an electrophotographic composition comprising a thermoplastic polymer, a charge adjuvant, a liquid carrier, and at least one microcapsule comprising at least one additive encapsulated within a shell. The shell of the microcapsule comprises a material having a melting temperature of at least 50 degrees C.

In some examples, the electrophotographic composition comprises a plurality of microcapsules, each microcapsule comprising at least one additive encapsulated within a shell. The additive(s) contained within the microcapsules may be the same or different.

The present disclosure also relates to an electrophotographic printing method comprising contacting an intermediate transfer blanket with a print substrate. The intermediate transfer blanket bears an image formed from at least one electrophotographic composition comprising a thermoplastic polymer, a charge adjuvant and at least one microcapsule comprising at least one additive encapsulated within a shell. The method comprises transferring the image from the intermediate transfer blanket to the print substrate, and releasing the additive from the microcapsule onto the print substrate.

In electrophotographic printing, a latent electrostatic image may be formed by selectively applying a pattern of electrostatic charge on a photoconductive surface. When an electrophotographic composition comprising charged toner particles is brought into contact with the selectively charged photoconductive surface under an applied electric field, the charged toner particles adhere to the image areas of the latent image, while background areas remain clean. The image may then be transferred to an intermediate transfer blanket, and then to a print substrate. In some examples, the blanket may be heated to facilitate transfer of the image to the print substrate.

An electrophotographic composition comprises a thermoplastic polymer, a charge adjuvant and a liquid carrier. Other additives, for example, colorants may also be incorporated into the electrophotographic composition, for instance, by combining the additives with at least some of the other toner components to form charged toner particles that selectively adhere to the image areas on the photoconductive surface across an electric field. However, certain additives may not be compatible with electrophotographic printing. For example, some materials (e.g. because of their polarity) may interfere with the electrostatic transfer of charged ink particles to the photoconductive surface. It may also be difficult to combine materials (e.g. liquids) with the other toner components to form charged toner particles that selectively adhere to the image areas on the photoconductive surface across an electric field.

The present inventors have found that, by using microcapsules to encapsulate additive(s) within a shell, it may be possible to electrophotographically print a wider range of additives onto a print substrate. The microcapsules, encapsulating the additive(s), may be transferred onto the photoconductive surface under an applied electric field. As the additive(s) are contained within the microcapsule's shell, they are less likely to have an influence the electrostatic transfer of toner particles to the photoconductive surface. Thus, in some examples, it may be possible to form an electrophotographic image on a photoconductive surface using additives that may otherwise have been considered to be incompatible with electrophotographic printing.

Once an image is formed on the photoconductive surface, this image may be transferred to a print substrate via an intermediate transfer blanket. The additive within the microcapsules may be released, for example, by heating the microcapsules to melt or rupture the microcapsules' shell. In some examples, the intermediate transfer blanket may be heated to facilitate transfer of the image to the print substrate. This heat may cause the shells of the microcapsules to melt or rupture, releasing the additive onto the print substrate. Thus, the additive may be released as the image is released from the intermediate transfer blanket onto the print substrate. In other examples, the additive may be released after the image has been transferred onto the print substrate, for instance, by heating the print substrate in a subsequent stage.

### Microcapsules

As described above, the microcapsule comprises at least one additive encapsulated within a shell. The shell may be formed of a material that melts above a threshold temperature to release the additive(s) encapsulated in the microcapsule onto the surface of the print substrate. Additionally, or alternatively, the shell may be formed of a material that ruptures under an applied force, for example, under a compressive force applied between the intermediate transfer blanket and a print substrate, and/or under an expansion force generated by the expansion of any gas contained within the microcapsule.

In some examples, the shell of the microcapsule may comprise a material having a melting temperature of at least 50 degrees C. In some examples, the shell may comprise a material having a melting temperature of at least 55 degrees C., for instance, at least 60 degrees C. or at least 65 degrees C. In some examples, the shell may comprise a material having a melting temperature of at least 70 degrees C., for instance, at least 75 degrees C.

The shell may comprise a material having a melting temperature of up to 130 degrees C., for example, up to 120 degrees C. or up to 110 degrees C. In some examples, the shell may comprise a material having a melting temperature of up to 100 degrees C., for instance, up to 95 degrees C., up to 90 degrees C., up to 85 degrees C., up to 80 degrees C. or up to 70 degrees C.

In some examples, the shell may comprise a material having a melting temperature of 50 to 130 degrees C., for instance, 55 to 120 degrees C., 60 to 110 degrees C., 65 to 100 degrees C., 70 to 95 degrees C. or 75 to 90 degrees C. In some examples, the shell may comprise a material having a melting temperature of 50 to 100 degrees C., for instance, 50 to 95 degrees C., 50 to 90 degrees C. In some examples, the melting temperature may be 50 to 70 degrees C. or 75 to 90 degrees C.

Any suitable material may be used to form the microcapsule shell. Examples include natural and synthetic materials. For example, carbohydrates, gums, waxes, fats, proteins, synthetic polymers and inorganic materials may be used. Mixtures of materials may be employed.

Examples of suitable carbohydrates include monosaccharides, disaccharides, oligosaccharides and polysaccharides. An example of a disaccharide is sucrose. Examples of polysaccharides include starch, modified starches, cellulose, dextrin, chitosan, alginates and carrageenan.

Examples of gums include arabic gum and xanthan gum.

Examples of waxes include paraffin wax.

Examples of fats include fatty acids, fatty alcohols, glycerides (e.g. monoglycerides, diglycerides and triglycerides), and hydrogenated oils and fats.

Examples of proteins include gluten, casein, gelatin and albumin.

Examples of inorganic materials include calcium sulfate and silicates and proteins.

Examples of suitable synthetic polymers include polyolefins (e.g. polyethylene), and polysiloxanes.

The shell material may be substantially transparent. For example, the shell material may be sufficiently transparent so as to have little effect on the printed image. In some examples, the shell material may melt and remain part of the printed image. Thus, in some examples, the shell material may have little impact on the visual appearance of the printed image.

The shell material may be substantially insoluble in the liquid carrier. For example, the shell material may be substantially insoluble in iso-paraffin, for instance, iso-paraffin carriers sold under the trademark Isopar®.

The microcapsules may be any suitable size. For example, the microcapsules suspended or dispersed in the liquid electrophotographic ink composition may have an average diameter 10 microns or less. In some examples, the microcapsules may have an average diameter of 5 microns or less, for instance 2 microns or less, 1 micron or less, or 0.5 micron or less.

In some examples, the microcapsules may have an average diameter of from 0.1 to 10 microns, for instance 0.5 to 8 microns, 1 to 6 microns or 2 to 5 microns. In one example, the average diameter may be 1 to 2 microns.

In some examples, at least 20% of the microcapsules present in the electrophotgraphic ink composition may have an average diameter of 5 microns or less. In some examples, at least 20% of the microcapsules present may have an average diameter of from 0.5 to 2 microns.

As described above, the microcapsules comprise at least one additive encapsulated within a shell. Any suitable additive may be employed. In some examples, a mixture of additives may be encapsulated.

In some examples, the additive may be a printing agent that may improve a property of the printed image. For example, the additive may be a printing agent that improves adhesion of the printed image on the print substrate, and/or a printing agent that improves the scratch and/or peel resistance of the printed image. In some examples, the additive maybe a printing agent that improves or alters the appearance of the printed image. For example, the printing agent may impart gloss to the printed image. In other examples, the printing agent may be a colorant or printing agent that enhances the visual appearance of the image. In some examples, the printing agent may be a varnish.

In some examples, the additive may be an additive that, when not encapsulated, has a negative effect on the electrophotographic printing process. For example, the additive may be polar or comprise a polar component (e.g. a polar solvent). When present in the electrophotographic composition in un-encapsulated form, such additives may interfere with the electrostatic transfer of charged toner particles to the photoconductive surface of the printer.

In some examples, the additive may be a solid or liquid. Where the additive is a liquid, the liquid may be a pure liquid or a mixture of liquids. In some examples, the liquid may be a solution of a dissolved solid(s). In some examples, the liquid may be a dispersion of dispersed solid(s). Thus, the liquid may include a solvent or carrier, for example a polar solvent or carrier.

Where the additive is solid, the solid may be a mixture of solids. The solid(s) may have a relatively low melting point. Thus, when heat is applied to melt the shell, the solid(s) contained within the microcapsule may also melt and distribute over the printed image.

In some examples, the solid may have a melting point of less than 60 degrees C., for instance, less than 50 degrees C., less than 40 degrees C. or less than 35 degrees C. In some examples, the solid may have a melting point greater than 20 degrees C., for instance, greater than 25 degrees C. In some examples, the solid may have a melting point of 20 to 50 degrees C., for example, 25 to 40 degrees C. or 25 to 35 degrees C.

Examples of additives include rosin esters, terpene phenolic resin, gum rosin, polyterpenes, hydrocarbon resins, alpha methyl styrene. These additives may be printing agents that can improve ink adhesion on the substrate.

Other examples of additives include polyfunctional aziridines e.g. pentaerythritol tris[3-(1-aziridinyl) propionate), and trimethylpropane tris(2-methyl-1-azridinepropionate). Other examples include ethylene glycol diglycidyl ether (EGDGE), trimethylolpropane triglycidyl ether, aromatic diglycidyl ether, triglycidyl ether, triglycidyl derivative of oxyaniline, tris(4-hydroxyphenyl)methane triglycidyl ether, diglycidyl 1,2-cyclohexanedicarboxylate, 1,4-cyclohexanedimethanol diglycidyl ether, mixture of cis and trans, tris(2,3-epoxypropyl) isocyanurate, poly(phenyl glycidylether)-co-formaldehyde, poly[(o-cresylglycidylether)-co-formaldehyde, poly(dimethylsiloxane), diglycidyl ether terminated, poly(E-co-GM), poly(E-co-MA-co-GM) and poly(ethylene-co-methyl acrylate-co-glycidyl methacrylate). These additives may be printing agents that can improve scratch resistance of the image on the print substrate.

The additive may comprise or consist of one or more polar solvents. Suitable polar solvents may be selected from water, alcohols, ketones, nitriles, ethers, esters, carboxylic acids, haloalkanes, organosulfur compounds, formamides, amines and amides. Examples include water, ethanol, methanol, acetone, methyl ethyl ketone, isopropanol, n-propanol, acetonitrile, DMSO (dimethyl sulfoxide) DMF (dimethyl formamide); ethanol, methanol, and propanol, polyethylene glycol, tetrahydrofuran, ethyl acetate, and dichloromethane. In some examples, such additives may be printing agents that can improve adhesion, for example, on certain print substrates. In other examples, such additives may be solvents or carriers for printing agents that are intended to be applied to the print substrate.

In one example, the additive may be a primer. Primers can be used to improve adhesion of the printed ink on the film substrate. Suitable primers include polymeric primers, for example, comprising a polymer and a solvent. In some examples, the primer comprises a polymer emulsion. Suitable solvents include aqueous solvents, for example, water or polar solvents, for example, ethanol. The concentration of polymer in the solvent may be 5 to 30 weight %, for example, 10 to 15 weight %.

In some examples, the primer may be selected from ethylene acrylic/methacrylic acid or acrylate/methacrylate copolymer emulsions, ethylene acrylic ionomers (saponified acrylic acid), polyamides, polyurethanes, polyamines, polyethylene imines, ethylene vinyl alcohol and ethylene vinyl acetate copolymer emulsions. The primer may also comprise a polymer comprising a polar group. Examples of polar groups include sulfonic, phosphonic, anhydride and silane groups.

In one example, a primer coating comprising a mixture of: a) about 60 to 95% by weight of a copolymer of ethylene and acrylic or methacrylic acid in an aqueous dispersion containing from about 10 to about 40% by weight total solids; and b) about 10 to 40% by weight of an adhesion enhancer comprising a hydrogenated rosin or rosin ester. Examples of such primers are described in U.S. Pat. No. 8,198,353.

In one example, the primer comprises polyethylene imine. In one example, the primer comprises a 1 to 30 weight % (e.g. 5 to 20 weight %) polyethylene imine dissolved in water. In some examples, the primer is a primer sold under the trademark Michelman® DP050 and Michelman® DP050.

The primer may also include at least one of crosslinkers, antifoaming agents, levelling (wetting) agents, and antiblocking agents.

The microcapsules are present in an amount of from 10 to 100% by weight of solids in the composition. In some examples, the microcapsules are present at a concentration of greater than 10 weight %, for example, 15 to 95 weight % of the total weight of solids in the electrophotographic composition. In one example, the microcapsules are present in an amount of 15 to 70 weight %, for example, 20 to 50 weight % of the total weight of solids in the electrophotographic composition.

As discussed above, the microcapsules may be transferred onto the photoconductive surface on application of an electric field. In some examples, the microcapsules may be combined or associated with one or more of the remaining solid component(s) of the electrophotographic composition to form charged toner particles. In some examples, the microcapsules may be charged by the charge adjuvant, the charge director or a combination of the charge adjuvant and charge director.

Encapsulation of the core ingredients can be achieved by several methods. Encapsulation techniques include spray drying, spray chilling or spray cooling, extrusion coating, fluidized-bed coating, coacervation, centrifugal suspension separation, emulsification and co-crystallization.

Spray drying: This process may involve the formation of an emulsion or suspension containing the additive (core) and wall material. The emulsion or suspension may then be nebulized, for example, in a drying chamber with a circulating gas (e.g. hot air). The circulating gas may cause the solvent or liquid carrier (e.g. water) to evaporate, causing the wall material to encapsulate the additive (core material). Encapsulating wall materials which may be used include gum arabic, modified starches, hydrolysed starches and whey proteins.

Spray chilling: In some examples, the material to encapsulated is mixed with the carrier and atomized by cooled or chilled air as opposed to using hot air when spray drying. The outer material can be, for example, a hydrogenated or fractionated vegetable oil.

Spray cooling: In some examples, this method may be based on the injection of a coolant (e.g. cold air) to effect particle solidification. Microparticles may be produced from a mixture containing of the additive (core) and wall material. This mixture may be nebulized by an atomizer and enters a chamber in which a coolant flows at low temperature. The reduction of temperature results in the solidification of the wall material, enabling the core to be encapsulated. The outer material can be a vegetable oil.

Extrusion: In some examples, this method may involve extruding a mixture of the additive (core) and wall material through a die or nozzle and solidifying the extrudate as droplets. Centrifugal force can also be used in the centrifugal extrusion technique.

Fluidized bed coating: This technique may involve suspending solid particles in a temperature and humidity-controlled chamber of high velocity air where the coating material is atomized. This technique may be used with hydrogenated vegetable oils, fatty acids, emulsifiers, waxes, starches or gums.

Coacervation: This technique may involve the deposition of a wall material (e.g. a polymer) around the additive (core) by altering the physicochemical characteristics of the medium, such as the temperature, ionic strength, pH and polarity. Coating materials which may be used include gelatin and gums.

Lyophilization: This method may involve dehydration of frozen material under vacuum sublimation.

Centrifugal suspension separation: This method may involve mixing the core ingredients with the wall materials and then adding them to a rotating disk. The microcapsules are then dried or chilled after removal from the disk. Wall materials can include, for example, fats, polyethylene glycol and diglycerides.

Emulsification: In an example of the emulsification method, the additive (core) material may be dispersed in a solution of the wall material. The dispersion may then be, for example, by the addition of a stabilizer. The solvent may then be removed, resulting in the formation of microcapsules.

Co-crystallization: In some examples, this method using sucrose as a matrix for the incorporation of core materials is used. The chosen core material is added to sugar syrup and the mixture agitated to allow crystallization to occur.

### Thermoplastic Resin

As described above, the electrophotographic composition comprises a thermoplastic polymer resin.

In some examples, the thermoplastic resin may be a polymer selected from ethylene or propylene acrylic acid co-polymers; ethylene or propylene methacrylic acid co-polymers; ethylene vinyl acetate co-polymers; co-polymers of ethylene or propylene (e.g. 80 wt % to 99.9 wt %) and alkyl (e.g. C1 to C5) esters of methacrylic or acrylic acid (e.g. 0.1 wt % to 20 wt %); co-polymers of ethylene (e.g. 80 wt % to 99.9 wt %), acrylic or methacrylic acid (e.g. 0.1 wt % to 20.0 wt %) and alkyl (e.g. C1 to C5) esters of methacrylic or acrylic acid (e.g. 0.1 wt % to 20 wt %); co-polymers of ethylene or propylene (e.g. 70 wt % to 99.9 wt %) and maleic anhydride (e.g. 0.1 wt % to 30 wt %); polyethylene; polystyrene; isotactic polypropylene (crystalline); co-polymers of ethylene and ethyl acrylate; polyesters; polyvinyl toluene; polyamides; styrene/butadiene co-polymers; epoxy resins; acrylic resins (e.g. co-polymer of acrylic or methacrylic acid and at least one alkyl ester of acrylic or methacrylic acid wherein alkyl may have from 1 to about 20 carbon atoms, such as methyl methacrylate (e.g. 50% to 90%)/methacrylic acid (e.g. 0 wt % to 20 wt %)/ethylhexylacrylate (e.g. 10 wt % to 50 wt %)); ethylene-acrylate terpolymers: ethylene-acrylic esters-maleic anhydride (MAH) or glycidyl methacrylate (GMA) terpolymers; ethylene-acrylic acid ionomers and combinations thereof.

The resin may comprise a polymer having acidic side groups. The polymer having acidic side groups may have an acidity of 50 mg KOH/g or more, in some examples an acidity of 60 mg KOH/g or more, in some examples an acidity of 70 mg KOH/g or more, in some examples an acidity of 80 mg KOH/g or more, in some examples an acidity of 90 mg KOH/g or more, in some examples an acidity of 100 mg KOH/g or more, in some examples an acidity of 105 mg KOH/g or more, in some examples 110 mg KOH/g or more, in some examples 115 mg KOH/g or more. The polymer having acidic side groups may have an acidity of 200 mg KOH/g or less, in some examples 190 mg or less, in some examples 180 mg or less, in some examples 130 mg KOH/g or less, in some examples 120 mg KOH/g or less. Acidity of a polymer, as measured in mg KOH/g can be measured using standard procedures known in the art, for example using the procedure described in ASTM D1386.

The resin may comprise a polymer, in some examples a polymer having acidic side groups, that has a melt flow rate of less than about 70 g/10 minutes, in some examples about 60 g/10 minutes or less, in some examples about 50 g/10 minutes or less, in some examples about 40 g/10 minutes or less, in some examples 30 g/10 minutes or less, in some examples 20 g/10 minutes or less, in some examples 10 g/10 minutes or less. In some examples, all polymers having acidic side groups and/or ester groups in the particles each individually have a melt flow rate of less than 90 g/10 minutes, 80 g/10 minutes or less, in some examples 80 g/10 minutes or less, in some examples 70 g/10 minutes or less, in some examples 70 g/10 minutes or less, in some examples 60 g/10 minutes or less.

The polymer having acidic side groups can have a melt flow rate of about 10 g/10 minutes to about 120 g/10 minutes, in some examples about 10 g/10 minutes to about 70 g/10 minutes, in some examples about 10 g/10 minutes to 40 g/10 minutes, in some examples 20 g/10 minutes to 30 g/10 minutes. The polymer having acidic side groups can have a melt flow rate of, in some examples, about 50 g/10 minutes to about 120 g/10 minutes, in some examples 60 g/10 minutes to about 100 g/10 minutes. The melt flow rate can be measured using standard procedures known in the art, for example as described in ASTM D1238.

The acidic side groups may be in free acid form or may be in the form of an anion and associated with one or more counterions, typically metal counterions, e.g. a metal selected from the alkali metals, such as lithium, sodium and potassium, alkali earth metals, such as magnesium or calcium, and transition metals, such as zinc. The polymer having acidic sides groups can be selected from resins such as co-polymers of ethylene and an ethylenically unsaturated acid of either acrylic acid or methacrylic acid; and ionomers thereof, such as methacrylic acid and ethylene-acrylic or methacrylic acid co-polymers which are at least partially neutralized with metal ions (e.g. Zn, Na, Li) such as SURLYN ionomers. The polymer comprising acidic side groups can be a co-polymer of ethylene and an ethylenically unsaturated acid of either acrylic or methacrylic acid, where the ethylenically unsaturated acid of either acrylic or methacrylic acid constitute from 5 wt % to about 25 wt % of the co-polymer, in some examples from 10 wt % to about 20 wt % of the co-polymer.

The resin may comprise two different polymers having acidic side groups. The two polymers having acidic side groups may have different acidities, which may fall within the ranges mentioned above. The resin may comprise a first polymer having acidic side groups that has an acidity of from 10 mg KOH/g to 110 mg KOH/g, in some examples 20 mg KOH/g to 110 mg KOH/g, in some examples 30 mg KOH/g to 110 mg KOH/g, in some examples 50 mg KOH/g to 110 mg KOH/g, and a second polymer having acidic side groups that has an acidity of 110 mg KOH/g to 130 mg KOH/g.

The resin may comprise two different polymers having acidic side groups: a first polymer having acidic side groups that has a melt flow rate of about 10 g/10 minutes to about 50 g/10 minutes and an acidity of from 10 mg KOH/g to 110 mg KOH/g, in some examples 20 mg KOH/g to 110 mg KOH/g, in some examples 30 mg KOH/g to 110 mg KOH/g, in some examples 50 mg KOH/g to 110 mg KOH/g, and a second polymer having acidic side groups that has a melt flow rate of about 50 g/10 minutes to about 120 g/10 minutes and an acidity of 110 mg KOH/g to 130 mg KOH/g. The first and second polymers may be absent of ester groups.

The ratio of the first polymer having acidic side groups to the second polymer having acidic side groups can be from about 10:1 to about 2:1. The ratio can be from about 6:1 to about 3:1, in some examples about 4:1.

The resin may comprise a polymer having a melt viscosity of 15000 poise or less, in some examples a melt viscosity of 10000 poise or less, in some examples 1000 poise or less, in some examples 100 poise or less, in some examples 50 poise or less, in some examples 10 poise or less; said polymer may be a polymer having acidic side groups as described herein. The resin may comprise a first polymer having a melt viscosity of 15000 poise or more, in some examples 20000 poise or more, in some examples 50000 poise or more, in some examples 70000 poise or more; and in some examples, the resin may comprise a second polymer having a melt viscosity less than the first polymer, in some examples a melt viscosity of 15000 poise or less, in some examples a melt viscosity of 10000 poise or less, in some examples 1000 poise or less, in some examples 100 poise or less, in some examples 50 poise or less, in some examples 10 poise or less. The resin may comprise a first polymer having a melt viscosity of more than 60000 poise, in some examples from 60000 poise to 100000 poise, in some examples from 65000 poise to 85000 poise; a second polymer having a melt viscosity of from 15000 poise to 40000 poise, in some examples 20000 poise to 30000 poise, and a third polymer having a melt viscosity of 15000 poise or less, in some examples a melt viscosity of 10000 poise or less, in some examples 1000 poise or less, in some examples 100 poise or less, in some examples 50 poise or less, in some examples 10 poise or less; an example of the first polymer is Nucrel 960 (from DuPont), and example of the second polymer is Nucrel 699 (from DuPont), and an example of the third polymer is AC-5120 or AC-5180 (from Honeywell). The first, second and third polymers may be polymers having acidic side groups as described herein. The melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 hz shear rate.

If the resin in the electrophotographic composition comprises a single type of polymer, the polymer (excluding any other components of the electrostatic composition) may have a melt viscosity of 6000 poise or more, in some examples a melt viscosity of 8000 poise or more, in some examples a melt viscosity of 10000 poise or more, in some examples a melt viscosity of 12000 poise or more. If the resin comprises a plurality of polymers all the polymers of the resin may together form a mixture (excluding any other components of the electrostatic composition) that has a melt viscosity of 6000 poise or more, in some examples a melt viscosity of 8000 poise or more, in some examples a melt viscosity of 10000 poise or more, in some examples a melt viscosity of 12000 poise or more. Melt viscosity can be measured using standard techniques. The melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 hz shear rate.

The resin may comprise two different polymers having acidic side groups that are selected from co-polymers of ethylene and an ethylenically unsaturated acid of either acrylic acid or methacrylic acid; or ionomers thereof, such as methacrylic acid and ethylene-acrylic or methacrylic acid co-polymers which are at least partially neutralized with metal ions (e.g. Zn, Na, Li) such as SURLYN ionomers. The resin may comprise (i) a first polymer that is a co-polymer of ethylene and an ethylenically unsaturated acid of either acrylic acid and methacrylic acid, wherein the ethylenically unsaturated acid of either acrylic or methacrylic acid constitutes from 8 wt % to about 16 wt % of the co-polymer, in some examples 10 wt % to 16 wt % of the co-polymer; and (ii) a second polymer that is a co-polymer of ethylene and an ethylenically unsaturated acid of either acrylic acid and methacrylic acid, wherein the ethylenically unsaturated acid of either acrylic or methacrylic acid constitutes from 12 wt % to about 30 wt % of the co-polymer, in some examples from 14 wt % to about 20 wt % of the co-polymer, in some examples from 16 wt % to about 20 wt % of the co-polymer in some examples from 17 wt % to 19 wt % of the co-polymer.

The resin may comprise a polymer having acidic side groups, as described above (which may be free of ester side groups), and a polymer having ester side groups. The polymer having ester side groups may be a thermoplastic polymer. The polymer having ester side groups may further comprise acidic side groups. The polymer having ester side groups may be a co-polymer of a monomer having ester side groups and a monomer having acidic side groups. The polymer may be a co-polymer of a monomer having ester side groups, a monomer having acidic side groups, and a monomer absent of any acidic and ester side groups. The monomer having ester side groups may be a monomer selected from esterified acrylic acid or esterified methacrylic acid. The monomer having acidic side groups may be a monomer selected from acrylic or methacrylic acid. The monomer absent of any acidic and ester side groups may be an alkylene monomer, including, but not limited to, ethylene or propylene. The esterified acrylic acid or esterified methacrylic acid may, respectively, be an alkyl ester of acrylic acid or an alkyl ester of methacrylic acid. The alkyl group in the alkyl ester of acrylic or methacrylic acid may be an alkyl group having 1 to 30 carbons, in some examples 1 to 20 carbons, in some examples 1 to 10 carbons; in some examples selected from methyl, ethyl, iso-propyl, n-propyl, t-butyl, iso-butyl, n-butyl and pentyl.

The polymer having ester side groups may be a co-polymer of a first monomer having ester side groups, a second monomer having acidic side groups and a third monomer which is an alkylene monomer absent of any acidic and ester side groups. The polymer having ester side groups may be a co-polymer of (i) a first monomer having ester side groups selected from esterified acrylic acid or esterified methacrylic acid, in some examples an alkyl ester of acrylic or methacrylic acid, (ii) a second monomer having acidic side groups selected from acrylic or methacrylic acid and (iii) a third monomer which is an alkylene monomer selected from ethylene and propylene. The first monomer may constitute 1% to 50% by weight of the co-polymer, in some examples 5% to 40% by weight, in some examples 5% to 20% by weight of the co-polymer, in some examples 5% to 15% by weight of the co-polymer. The second monomer may constitute 1% to 50% by weight of the co-polymer, in some examples 5% to 40% by weight of the co-polymer, in some examples 5% to 20% by weight of the co-polymer, in some examples 5% to 15% by weight of the co-polymer. The first monomer can constitute 5% to 40% by weight of the co-polymer, the second monomer constitutes 5% to 40% by weight of the co-polymer, and with the third monomer constituting the remaining weight of the co-polymer. In some examples, the first monomer constitutes 5% to 15% by weight of the co-polymer, the second monomer constitutes 5% to 15% by weight of the co-polymer, with the third monomer constituting the remaining weight of the co-polymer. In some examples, the first monomer constitutes 8% to 12% by weight of the co-polymer, the second monomer constitutes 8% to 12% by weight of the co-polymer, with the third monomer constituting the remaining weight of the co-polymer. In some examples, the first monomer constitutes about 10% by weight of the co-polymer, the second monomer constitutes about 10% by weight of the co-polymer, and with the third monomer constituting the remaining weight of the co-polymer. The polymer may be selected from the Bynel® class of monomer, including Bynel 2022 and Bynel 2002, which are available from DuPont®.

The polymer having ester side groups may constitute 1% or more by weight of the total amount of the resin polymers, e.g. thermoplastic resin polymers, in the liquid electrophotographic composition, e.g. the total amount of the polymer or polymers having acidic side groups and polymer having ester side groups. The polymer having ester side groups may constitute 5% or more by weight of the total amount of the resin polymers, e.g. thermoplastic resin polymers, in some examples 8% or more by weight of the total amount of the resin polymers, e.g. thermoplastic resin polymers, in some examples 10% or more by weight of the total amount of the resin polymers, e.g. thermoplastic resin polymers, in some examples 15% or more by weight of the total amount of the resin polymers, e.g. thermoplastic resin polymers, in some examples 20% or more by weight of the total amount of the resin polymers, e.g. thermoplastic resin polymers, in some examples 25% or more by weight of the total amount of the resin polymers, e.g. thermoplastic resin polymers, in some examples 30% or more by weight of the total amount of the resin polymers, e.g. thermoplastic resin polymers, in some examples 35% or more by weight of the total amount of the resin polymers, e.g. thermoplastic resin polymers, in the liquid electrophotographic composition. The polymer having ester side groups may constitute from 5% to 50% by weight of the total amount of the resin polymers, e.g. thermoplastic resin polymers, in the liquid electrophotographic composition, in some examples 10% to 40% by weight of the total amount of the resin polymers, e.g. thermoplastic resin polymers, in the liquid electrophotographic composition, in some examples 5% to 30% by weight of the total amount of the resin polymers, e.g. thermoplastic resin polymers, in the liquid electrophotographic composition, in some examples 5% to 15% by weight of the total amount of the resin polymers, e.g. thermoplastic resin polymers, in the liquid electrophotographic composition in some examples 15% to 30% by weight of the total amount of the resin polymers, e.g. thermoplastic resin polymers, in the liquid electrophotographic composition.

The polymer having ester side groups may have an acidity of 50 mg KOH/g or more, in some examples an acidity of 60 mg KOH/g or more, in some examples an acidity of 70 mg KOH/g or more, in some examples an acidity of 80 mg KOH/g or more. The polymer having ester side groups may have an acidity of 100 mg KOH/g or less, in some examples 90 mg KOH/g or less. The polymer having ester side groups may have an acidity of 60 mg KOH/g to 90 mg KOH/g, in some examples 70 mg KOH/g to 80 mg KOH/g.

The polymer having ester side groups may have a melt flow rate of about 10 g/10 minutes to about 120 g/10 minutes, in some examples about 10 g/10 minutes to about 50 g/10 minutes, in some examples about 20 g/10 minutes to about 40 g/10 minutes, in some examples about 25 g/10 minutes to about 35 g/10 minutes.

The polymer, polymers, co-polymer or co-polymers of the resin can in some examples be selected from the Nucrel family of toners (e.g. Nucrel 403™, Nucrel 407™, Nucrel 609HS™, Nucrel 908HS™, Nucrel 1202HC™, Nucrel 30707™, Nucrel 1214™, Nucrel 903™, Nucrel 3990™, Nucrel 910™, Nucrel 925™, Nucrel 699™, Nucrel 599™, Nucrel 960™, Nucrel RX76™, Nucrel 2806™, Bynell 2002, Bynell 2014, Bynell 2020 and Bynell 2022, (sold by E. I. du PONT)), the Aclyn family of toners (e.g. Aclyn 201, Aclyn 246, Aclyn 285, and Aclyn 295), and the Lotader family of toners (e.g. Lotader 2210, Lotader, 3430, and Lotader 8200 (sold by Arkema)).

The resin can constitute about 5 to 90%, in some examples about 50 to 80%, by weight of the solids of the liquid electrophotographic composition. The resin can constitute about 60 to 95%, in some examples about 70 to 95%, by weight of the solids of the liquid electrophotographic composition.

### Charge Adjuvant

The electrophotographic composition includes a charge adjuvant. A charge adjuvant may be present with a charge director, and may be different to the charge director, and act to increase and/or stabilise the charge on particles, e.g. resin-containing particles, of an electrostatic composition. The charge adjuvant can include, but is not limited to, barium petronate, calcium petronate, Co salts of naphthenic acid, Ca salts of naphthenic acid, Cu salts of naphthenic acid, Mn salts of naphthenic acid, Ni salts of naphthenic acid, Zn salts of naphthenic acid, Fe salts of naphthenic acid, Ba salts of stearic acid, Co salts of stearic acid, Pb salts of stearic acid, Zn salts of stearic acid, Al salts of stearic acid, Cu salts of stearic acid, Fe salts of stearic acid, metal carboxylates (e.g. Al tristearate, Al octanoate, Li heptanoate, Fe stearate, Fe distearate, Ba stearate, Cr stearate, Mg octanoate, Ca stearate, Fe naphthenate, Zn naphthenate, Mn heptanoate, Zn heptanoate, Ba octanoate, Al octanoate, Co octanoate, Mn octanoate, and Zn octanoate), Co lineolates, Mn lineolates, Pb lineolates, Zn lineolates, Ca oleates, Co oleates, Zn palmitate, Ca resinates, Co resinates, Mn resinates, Pb resinates, Zn resinates, AB diblock co-polymers of 2-ethylhexyl methacrylate-co-methacrylic acid calcium, and ammonium salts, co-polymers of an alkyl acrylamidoglycolate alkyl ether (e.g. methyl acrylamidoglycolate methyl ether-co-vinyl acetate), and hydroxy bis(3,5-di-tert-butyl salicylic) aluminate monohydrate. In some examples, the charge adjuvant is aluminium di and/or tristearate and/or aluminium di and/or tripalmitate.

The charge adjuvant can constitute about 0.1 to 5% by weight of the solids of the liquid electrophotographic composition. The charge adjuvant can constitute about 0.5 to 4 by weight of the solids of the liquid electrophotographic composition. The charge adjuvant can constitute about 1 to 3% by weight of the solids of the liquid electrophotographic composition.

### Charge Director

A charge director may be added to the electrophotographic composition. In some examples, the charge director comprises nanoparticles of a simple salt and a salt of the general formula MAₙ, wherein M is a barium, n is 2, and A is an ion of the general formula [R₁—O—C(O)CH₂CH(SO₃⁻)C(O)—O—R₂], where each of R₁ and R₂ is an alkyl group.

The sulfosuccinate salt of the general formula MAₙ is an example of a micelle forming salt. The charge director may be substantially free or free of an acid of the general formula HA, where A is as described above. The charge director may comprise micelles of said sulfosuccinate salt enclosing at least some of the nanoparticles. The charge director may comprise at least some nanoparticles having a size of 10 nm or less, in some examples 2 nm or more (e.g. 4-6 nm).

The simple salt may comprise a cation selected from Mg, Ca, Ba, NH₄ tert-butyl ammonium, Li⁺, and Al⁺³, or from any sub-group thereof. In one example, the simple salt is an inorganic salt, for instance, a barium salt. The simple salt may comprise an anion selected from SO₄²⁻, PO³⁻, NO₃⁻, HPO₄²⁻, CO₃²⁻, acetate, trifluoroacetate (TFA), Cl⁻, Bf, F⁻, ClO₄⁻, and TiO₃⁴⁻, or from any sub-group thereof. In some examples, the simple salt comprises a hydrogen phosphate anion.

The simple salt may be selected from CaCO₃, Ba₂TiO₃, Al₂(SO₄)₃, Al(NO₃)₃, Ca₃(PO₄)₂, BaSO₄, BaHPO₄, Ba₂(PO₄)₃, CaSO₄, (NH₄)₂CO₃, (NH₄)₂SO₄, NH₄OAc, Tert-butyl ammonium bromide, NH₄NO₃, LiTFA, Al₂(SO₄)₃, LiClO₄ and LiBF₄, or any sub-group thereof. In one example, the simple salt may be BaHPO₄.

In the formula [R₁—O—C(O)CH₂CH(SO₃⁻)C(O)—O—R₂], in some examples, each of R₁ and R₂ is an aliphatic alkyl group. In some examples, each of R₁ and R₂ independently is a C₆₋₂₅ alkyl. In some examples, said aliphatic alkyl group is linear. In some examples, said aliphatic alkyl group is branched. In some examples, said aliphatic alkyl group includes a linear chain of more than 6 carbon atoms. In some examples, R₁ and R₂ are the same. In some examples, at least one of R₁ and R₂ is C₁₃H₂₇.

In an electrophotographic composition, the charge director can constitute about 0.001% to 20%, in some examples 0.01 to 20% by weight, in some examples 0.01 to 10% by weight, in some examples 0.01 to 1% by weight of the solids of the electrostatic composition. The charge director can constitute about 0.001 to 0.15% by weight of the solids of the liquid electrophotographic composition, in some examples 0.001 to 0.15%, in some examples 0.001 to 0.02% by weight of the solids of the liquid electrophotographic composition. In some examples, the charge director imparts a negative charge on the electrostatic composition. The particle conductivity may range from 50 to 500 pmho/cm, in some examples from 200-350 pmho/cm.

### Carrier Liquid

The carrier liquid for the liquid electrophotographic composition can act as a dispersing medium for the other components in the electrostatic composition. For example, the carrier liquid can comprise or be a hydrocarbon, silicone oil, vegetable oil, etc. The carrier liquid can include, but is not limited to, an insulating, non-polar, non-aqueous liquid that can be used as a medium for toner particles. The carrier liquid can include compounds that have a resistivity in excess of about 10⁹ ohm-cm. The carrier liquid may have a dielectric constant below about 5, in some examples below about 3. The carrier liquid can include, but is not limited to, hydrocarbons. The hydrocarbon can include, but is not limited to, an aliphatic hydrocarbon, an isomerized aliphatic hydrocarbon, branched chain aliphatic hydrocarbons, aromatic hydrocarbons, and combinations thereof. Examples of the carrier liquids include, but are not limited to, aliphatic hydrocarbons, isoparaffinic compounds, paraffinic compounds, dearomatized hydrocarbon compounds, and the like. In some examples, the carrier liquid is an isoparaffinic liquid. In particular, the carrier liquids can include, but are not limited to liquids sold under the trademarks, Isopar-G™, Isopar-H™, Isopar-L™, Isopar-M™, Isopar-K™, Isopar-V™, Norpar 12™, Norpar 13™, Norpar 15™, Exxol D40™, Exxol D80™, Exxol D100™, Exxol D130™, and Exxol D140™ (each sold by EXXON CORPORATION); Teclen N-16™, Teclen N-20™, Teclen N-22™, Nisseki Naphthesol L™, Nisseki Naphthesol M™, Nisseki Naphthesol H™, #0 Solvent L™, #0 Solvent M™, #0 Solvent H™, Nisseki Isosol 300™, Nisseki Isosol 400™, AF-4™, AF-5™, AF-6™ and AF-7™ (each sold by NIPPON OIL CORPORATION); IP Solvent 1620™ and IP Solvent 2028™ (each sold by IDEMITSU PETROCHEMICAL CO., LTD.); Amsco OMS™ and Amsco 460™ (each sold by AMERICAN MINERAL SPIRITS CORP.); and Electron, Positron, New II, Purogen HF (100% synthetic terpenes) (sold by ECOLINK™).

Before printing, the carrier liquid can constitute about 20% to 99.5% by weight of the electrostatic composition, in some examples 50% to 99.5% by weight of the electrostatic composition. Before printing, the carrier liquid may constitute about 40 to 90% by weight of the electrostatic composition. Before printing, the carrier liquid may constitute about 60% to 80% by weight of the electrostatic composition. Before printing, the carrier liquid may constitute about 90% to 99.5% by weight of the electrostatic composition, in some examples 95% to 99% by weight of the electrostatic composition.

The composition when printed on the print substrate, may be substantially free from carrier liquid. In an electrostatic printing process and/or afterwards, the carrier liquid may be removed, e.g. by an electrophoresis processes during printing and/or evaporation, such that substantially just solids are transferred to the print substrate. Substantially free from carrier liquid may indicate that the ink printed on the print substrate contains less than 5 wt % carrier liquid, in some examples, less than 2 wt % carrier liquid, in some examples less than 1 wt % carrier liquid, in some examples less than 0.5 wt % carrier liquid. In some examples, the ink printed on the print substrate is free from carrier liquid.

### Colorants

The electrophotographic composition and/or ink printed on the print substrate may further include a colorant. The colorant may be selected from a pigment, dye and a combination thereof. The colorant may be transparent, unicolor or composed of any combination of available colours. The colorant may be selected from a cyan colorant, a yellow colorant, a magenta colorant and a black colorant. The electrophotographic composition and/or ink printed on the print substrate may include a plurality of colorants. The electrophotographic composition and/or ink printed on the print substrate may include a first colorant and second colorant, which are different from one another. Further colorants may also be present with the first and second colorants. The electrophotographic composition and/or ink printed on the print substrate may include first and second colorants where each is independently selected from a cyan colorant, a yellow colorant, a magenta colorant and a black colorant. In some examples, the first colorant includes a black colorant, and the second colorant includes a non-black colorant, for example a colorant selected from a cyan colorant, a yellow colorant and a magenta colorant. The colorant may be selected from a phthalocyanine colorant, an indigold colorant, an indanthrone colorant, a monoazo colorant, a diazo colorant, inorganic salts and complexes, dioxazine colorant, perylene colorant, anthraquinone colorants, and any combination thereof.

Where present, the colorant may be present in an amount of 0.1 to 10 weight %, for instance, 2 to 5 weight % of the total weight of solids of the composition.

In some examples, the electrophotographic composition is devoid of colorant. The electrophotographic composition may be a transparent ink or a varnish composition that is electrophotographically printed over an image formed of an electrophotographic ink.

In one example, the electrophotographic composition is a transparent ink. The transparent ink may be printed beneath or over a visible printed image (e.g. a 2-D image) to provide the desired loft effect. The visible printed image may be printed using any suitable liquid electrophotographic ink composition comprising a colorant.

### Printing Process

As described above, the present disclosure relates to an electrophotographic printing method that comprises contacting an intermediate transfer blanket with a print substrate. The intermediate transfer blanket bears an image formed from at least one electrophotographic composition comprising a thermoplastic polymer, a charge adjuvant and at least one microcapsule comprising at least one additive encapsulated within a shell. The image is then transferred from the intermediate transfer blanket to the print substrate, and the additive released on the print substrate.

The image on the intermediate transfer blanket may be formed by selectively charging a photoconductive surface to form a latent electrostatic image on the photoconductive surface. An electrophotographic composition may then be electrostatically transferred to the photoconductive surface to form an image on the photoconductive surface that corresponds to the latent electrostatic image.

The microcapsules may remain intact as the toner particles are electrostatically transferred to the photoconductive surface. Accordingly, the additive within the microcapsules may have little influence or impact on the electrostatic transfer of toner particles onto the photoconductive surface. Because the additive may be isolated from this stage of the process, it may be possible to encapsulate additives that would otherwise be incompatible with this stage of the printing process.

In some examples, the electrostatic transfer step is performed at a temperature of less than 50 degrees C. Accordingly, the image on the photoconductive surface may be formed at a temperature of less than 50 degrees C. In some examples, the electrostatic transfer step is performed at a temperature of 10 to 45 degrees C., for instance, 15 to 40 degrees C., or 20 to 35 degrees C., or 25 to 30 degrees C. Accordingly, the image on the photoconductive surface may be formed at a temperature of 10 to 45 degrees C., for instance, 15 to 40 degrees C., or 20 to 35 degrees C., or 25 to 30 degrees C. In some examples, the electrostatic transfer step is performed at ambient temperature. Accordingly, the image on the photoconductive surface may be formed at ambient temperature.

The photoconductive surface may then be contacted with an intermediate transfer blanket to transfer the image onto the intermediate transfer blanket. This transfer may also be facilitated by the application of an electric field. In some examples, the transfer of the image from the photoconductive surface to the intermediate transfer blanket may be described as the “first transfer”.

After the first transfer, the image is transferred from the intermediate transfer blanket onto a print substrate. This transfer is described in some examples are the “second transfer”. In some examples, the intermediate transfer blanket is mounted on a cylinder, which is mounted adjacent an impression cylinder. A print substrate may be fed between the cylinders and pressure may be applied to transfer the image from the intermediate transfer blanket to the print substrate.

The image on the intermediate transfer blanket may be heated. This may help to fuse and dry the image onto the intermediate transfer blanket. Heat may also melt at least a portion of the shell of the microcapsule to release the additive on the print substrate. Alternatively, or additionally, heat may cause any gas contained in the microcapsules to expand, causing the microcapsules to rupture. Heating may also help to facilitate transfer of the image from the intermediate transfer blanket to the print substrate.

In some examples, the intermediate transfer blanket may be heated so as to heat the image on the intermediate transfer blanket to at least the melting point of the wall material of the microcapsules. In one example, the intermediate transfer blanket is heated to a temperature of at least 50 degrees C. In some examples, the intermediate transfer blanket may be heated to at least 55 degrees C., for instance, at least 60 degrees C. or at least 65 degrees C. In some examples, the intermediate transfer blanket may be heated to at least 70 degrees C., for instance, at least 75 degrees C.

In some examples, the intermediate transfer blanket may be heated to a temperature of up to 130 degrees C., for example, up to 120 degrees C. or up to 110 degrees C. In some examples, the intermediate transfer blanket may be heated to a temperature of up to 100 degrees C., for instance, up to 95 degrees C., up to 90 degrees C., up to 85 degrees C., up to 80 degrees C. or up to 70 degrees C.

In some examples, the intermediate transfer blanket may be heated to a temperature of 50 to 130 degrees C., for instance, 55 to 120 degrees C., 60 to 110 degrees C., 65 to 100 degrees C., 70 to 95 degrees C. or 75 to 90 degrees C. In some examples, the intermediate transfer blanket may be heated to a temperature of 50 to 100 degrees C., for instance, 50 to 95 degrees C., 50 to 90 degrees C. In some examples, the intermediate transfer blanket may be heated to a temperature of may be 50 to 70 degrees C. or 75 to 90 degrees C.

In addition to heating the image on the intermediate transfer blanket, it may be possible to apply pressure between the intermediate transfer blanket and the print substrate. This pressure may help to cause the microcapsules to rupture to release the additive(s) onto the print substrate.

On the press machine, the electrophotgraphic composition may be transferred electrically from the paste ink proofer (PIP) to the intermediate transfer blanket. The composition may be heated during the first transfer to a temperature of 50 to 130 degrees C., for instance, 55 to 120 degrees C., 60 to 110 degrees C., 65 to 100 degrees C., 70 to 95 degrees C. or 75 to 90 degrees C. In some examples, the composition may be heated to a temperature of 50 to 100 degrees C., for instance, 50 to 95 degrees C., 50 to 90 degrees C. In some examples, the composition may be heated to a temperature of may be 50 to 70 degrees C. or 75 to 90 degrees C.

During the first transfer, the capsules may begin to open by melting or rupturing and the core material will be exposed to the interface between the ink and the substrate. By melting or rupturing at least a portion of the shell of the microcapsules, the core material may be exposed to the electrophotgraphic ink composition and then released on the print substrate. Any solvent which has been encapsulated will evaporate during the ink transfer from the blanket to the print substrate.

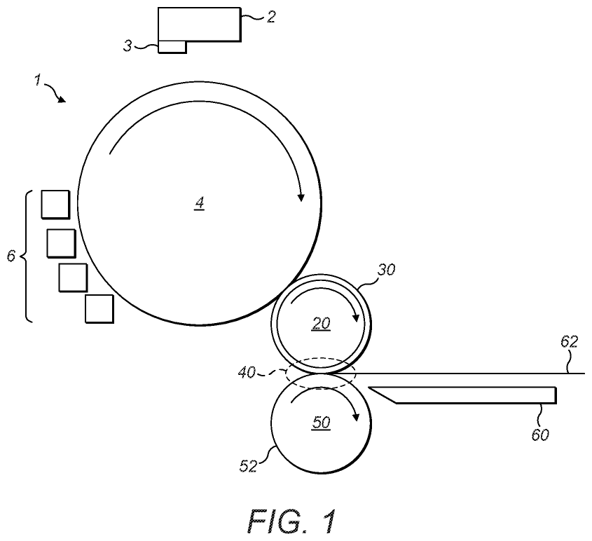

FIG. 1 is a schematic illustration of an example of an electrophotographic printer that may be used to perform an example of a electrophotographic printing method described herein. The electrophotographic printer may be a liquid electrophotographic printing apparatus or LEP printing apparatus.

The LEP printing apparatus includes a photo charging unit 2 and a photo-imaging cylinder 4. The image may be initially formed on a photoimaging plate (also known as a photoconductive surface), in this example in the form of photo-imaging cylinder 4, before being transferred to a release layer 30 of the intermediate transfer member (ITM) 20 which is in the form of a roller (first transfer), and then from the release layer 30 of the ITM 20 to a print substrate 62 (second transfer).

An initial image may be formed on rotating photo-imaging cylinder 4 by photo charging unit 2. Firstly, photo charging unit 2 may deposit a uniform static charge on photo-imaging cylinder 4. Then a laser imaging portion 3 of photo charging unit 2 may dissipate the static charges in selected portions of the image area on the photo-imaging cylinder 4 to leave a latent electrostatic image. The latent electrostatic image may be an electrostatic charge pattern representing the image to be printed.

A liquid electrophotographic composition of the present disclosure may then be transferred to photo-imaging cylinder 4 by binary ink developer (BID) units 6. The BID units 6 present a uniform film of liquid electrophotographic composition to photo-imaging cylinder 4. The liquid electrophotographic composition contains electrically charged toner particles, comprising the microcapsules, which, by virtue of an appropriate potential on the electrostatic image areas, are attracted to the latent electrostatic image on photo-imaging cylinder 4. The liquid electrophotographic composition does not adhere to the uncharged, non-image areas and forms a developed toner image on the surface of the latent electrostatic image. Photo-imaging cylinder 4 then has an electrophotographic image on its surface.

The developed toner image may then be transferred from photo-imaging cylinder 4 to the release layer 30 of blanket 20 by electrical forces. The image is then dried and fused on the release layer 30 of blanket 20 before being transferred from release layer 30 of blanket 20 to a print substrate disposed on impression cylinder 50. The process may then be repeated for each of the layers of electrophotographic composition (e.g. coloured inks) to be included in the final image.

Between the first and second transfers, the solid content of the developed toner image may be increased and the electrophotographic composition is fused on to blanket 20. For example, the solid content of the developed toner image deposited on release layer 30 after the first transfer may be around 20%, by the second transfer the solid content of the developed toner image may be around 80-90%. This drying and fusing may be achieved by using elevated temperatures and airflow-assisted drying. In some examples, blanket 20 may be heated. This heat may help to release the additive onto the print substrate.

### Print Substrate

The print substrate may be any suitable substrate. The substrate may be any suitable substrate capable of having an image printed thereon. The substrate may include a material selected from an organic or inorganic material. The material may include a natural polymeric material, e.g. cellulose. The material may include a synthetic polymeric material, e.g. a polymer formed from alkylene monomers, including, but not limited to, polyethylene and polypropylene, polyethylene terephthalate (PET) and co-polymers such as styrene-polybutadiene. The polypropylene may, in some examples, be biaxially orientated polypropylene. The material may include a fabric or metal, which may be in sheet form. The metal may be selected from or made from, for instance, aluminium (Al), silver (Ag), tin (Sn), copper (Cu), mixtures thereof. In an example, the substrate includes a cellulosic paper. In an example, the cellulosic paper is coated with a polymeric material, e.g. a polymer formed from styrene-butadiene resin. In some examples, the cellulosic paper has an inorganic material bound to its surface (before printing with ink) with a polymeric material, wherein the inorganic material may be selected from, for example, kaolinite or calcium carbonate. The substrate is, in some examples, a cellulosic print substrate such as paper. The cellulosic print substrate is, in some examples, a coated cellulosic print.

The substrate may be heat resistant to temperatures of at least 100 degrees C., for example, at least 120 degrees C. In one example, the substrate is heat resistant to temperatures of at least 130 degrees C., for instance above 200 degrees C. An example of a heat resistant substrate includes cellulose substrates that are substantially free of lignin, for example, sold under the trademarks FlexDura®. Other examples include heat resistant polymer films or substrates, for example, having melting temperatures of at least 100 degrees C., for example, at least 120 degrees C. In one example, the melting temperature is at least 130 degrees C., for instance above 200 degrees C.

### EXAMPLES

### Example 1

In this example, the effect of releasing polar additives onto a print substrate was evaluated.

In this example, an electrophotographic composition was printed onto a PET print substrate (pre-treated with corona).

Full transfer of the ink from the blanket to the plastic film occurred. However, the image showed very poor peel resistance in the absence of primer.

The procedure above was repeated. However, the PET print substrate was spread with a thin layer of water or ethanol prior to being introduced to the printer.

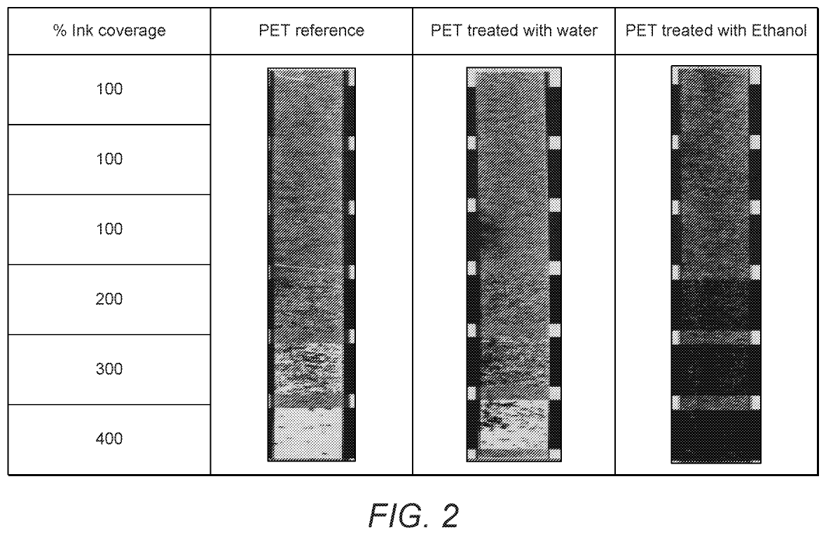

FIG. 2 shows the tested peel resistance of the printed images.

There was slight improvement in ink adhesion when the PET print substrate was treated with water. However, there was a more significant improvement in ink adhesion when the PET substrate was treated with ethanol.

Water and ethanol may interfere with the electrostatic transfer of ink onto the photoconductive surface of an electrophotographic printer because of their polarity.

However, this Example shows that these polar solvents may nevertheless improve ink adhesion. Spreading the water and ethanol onto the print substrates prior to printing simulates the release of water and ethanol from the microcapsule and migration to the ink interface onto the print substrate. The introduction of such additives into the process improves print quality.

### Example 2

This Example was performed on press machine 6600.

In this example, a PET print substrate was pre-treated by corona. An image was then printed onto the substrate using the electrophotographic ink composition described in Example 1 using an HP Indigo WS 6600 printing press. An aqueous primer DIGIPRIME 050® (MICHELMAN) was sprayed on the blanket during the printing.

The procedure was repeated with a fresh blanket devoid of primer.

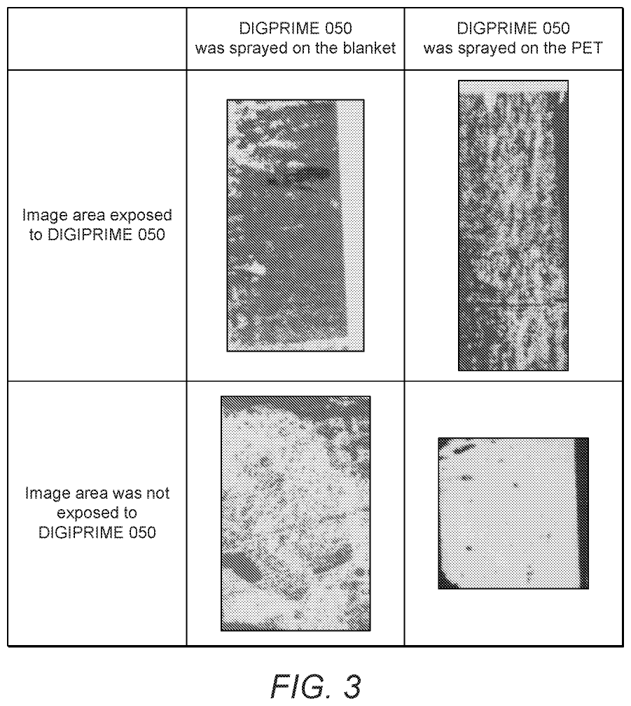

FIG. 3 shows the peel resistances of images exposed to the primer via the blanket, and peel resistances of images devoid of primer. Peel resistance tests were performed by the application of sticky tape (3M)) over the images and inspecting the images after the sticky tape was removed. It can be seen that the peel resistance of the images exposed to primer is superior. The experiment demonstrates that the primer may be released onto the print substrate during the second transfer to provide superior adhesion. Thus, in some examples, an in-line priming step prior to electrophotographic printing may be avoided.

As an alternative, the primer, DIGIPRIME® 050 (Michelman) was sprayed on the PET print substrate immediately before it engaged with the blanket. After the PET was printed, the peel test was performed. The results are also shown in FIG. 3.

The results of FIG. 3 show that the primer may be released onto the print substrate during the second transfer to provide superior adhesion. Since the DIGIPRIME® 050 contains water, it may not be possible to add it directly to the ink. By encapsulating the primer directly into the microcapsules, the microcapsules are part of the ink formulation and can improve adhesion.

### Example 3

Table 1 below shows examples of some microcapsules which may be used in the electrophotographic compositions described herein:

TABLE 1

| Microcapsule Shell | Average Microcapsule | |
|---|---|---|
| Material | Diameter | Core Material |
| Modified starch | 1 to 2 microns | Ethylenimine |
| Diacylglycerol | 1 to 2 microns | Polyamide |
| Modified | 1 to 2 microns | Polyamide with |
| polyurethane | | Isopropyl Alcohol |

1. An electrophotographic composition comprising:
a thermoplastic polymer,
a charge adjuvant,
a liquid carrier, and
at least one microcapsule comprising at least one additive encapsulated within a shell, wherein the shell of the microcapsule comprises a material having a melting temperature of at least 50 degrees C.

2. The electrophotographic composition according to claim 1, wherein the thermoplastic polymer is selected from at least one of a copolymer of an olefin and acrylic acid, and a copolymer of an olefin and methacrylic acid.

3. The electrophotographic composition according to claim 1, wherein the additive is a liquid or solid.

4. The electrophotographic composition according to claim 3, wherein the liquid comprises a solid printing agent dissolved or dispersed in a polar solvent.

5. The electrophotographic composition according to claim 4, wherein the solid printing agent comprises a primer.

6. The electrophotographic composition according to claim 1, wherein the diameter of the microcapsule is from 1 to 2 microns.

7. The electrophotographic composition according to claim 1, wherein the shell of the microcapsule is transparent.

8. The electrophotographic composition according to claim 1, which further comprises a charge director.

9. The electrophotographic composition according to claim 1, wherein the shell of the microcapsule comprises a material having a melting temperature of 50 to 90 degrees C.

10. The electrophotographic composition according to claim 1, wherein the microcapsules are present in an amount of from 10 to 100% by weight of solids in the composition.

11. The electrophotographic composition according to claim 1, wherein the shell of the microcapsules comprises a material selected from one or more of xanthan gum, arabic gum, fatty alcohols, fatty acids, hydrocarbon resins, mono, di and triacyl glycol, natural waxes, polyethylene, alginate, carrageenan, caseinate, chitosan, modified cellulose, gelatin, latex, starch, ethyl cellulose and polyethylene.

12. An electrophotographic printing method comprising:
contacting an intermediate transfer blanket with a print substrate, wherein the intermediate transfer blanket bears an image formed from at least one electrophotographic composition comprising a thermoplastic polymer, a charge adjuvant and at least one microcapsule comprising at least one additive encapsulated within a shell;
transferring the image from the intermediate transfer blanket to the print substrate, and releasing the additive on the print substrate.

13. A method according to claim 12, wherein the intermediate transfer blanket bearing the image is formed by
selectively charging a photoconductive surface to form a latent electrostatic image on the photoconductive surface,
electrostatically transferring electrophotographic composition to the photoconductive surface to form an image on the photoconductive surface that corresponds to the latent electrostatic image;
contacting the photoconductive surface with an intermediate transfer blanket to transfer the image onto the intermediate transfer blanket.

14. A method according to claim 12, which the image on the intermediate transfer blanket is heated to facilitate transfer of the image from the intermediate transfer blanket to the print substrate and to melt at least a portion of the shell of the microcapsule to release the additive on the print substrate.

15. A method according to claim 14, wherein the image on the intermediate transfer blanket is heated to a temperature of at least 50 degrees C.
